(19) United States
(12) Patent Application Publication
(10) Pub. No.: US 2023/0241870 A1
(43) Pub. Date: Aug. 3, 2023

(54) MULTI-LAYERED MATS AND METHODS OF MANUFACTURE THEREOF

(71) Applicant: Donarra Extrusions LLC, Manchester, NH (US)

(72) Inventors: David Guimond, Elkins, NH (US); Christopher Guimond, Elkins, NH (US); Kimberly Guimond, Elkins, NH (US)

(21) Appl. No.: 17/587,375

(22) Filed: Jan. 28, 2022

(51) Int. Cl. B32B 27/08; B32B 3/02; B32B 7/022; B32B 27/32; B32B 27/18; B32B 25/14; B32B 25/08; B32B 3/06; B32B 3/26; E01C 5/22

(52) U.S. Cl. CPC B32B 27/08; B32B 3/02; B32B 7/022; B32B 27/32; B32B 27/18; B32B 25/14; B32B 25/08; B32B 3/06; B32B 3/266; E01C 5/22; B32B 2274/00; B32B 2250/02; B32B 2250/24; B32B 2307/536; B32B 2471/04

(57) ABSTRACT

Disclosed embodiments may include a coextruded mat for ground protection. The coextruded mat may include a first material, a second material that is harder than the first material, and an additive blended with the second material to create a third material. The first material may bonded to the third material. The first material may include a plastomer and the second material may include polyethene.

### FIELD OF THE DISCLOSURE

The present disclosure relates generally to multi-layered mats and methods of making the mats. In particular, the present disclosure relates to mats having two layers bonded together with a lower layer being harder than an upper layer and method making the mats using coextrusion.

### BACKGROUND

Existing ground mats tend to be slippery whether dry or wet. This makes it next to impossible to ensure that the ground (e.g., golf courses) the existing ground mats were designed to protect remains protected from vehicles (e.g., dump trucks). Instead, vehicles may not be able to grip the top surface of the mat causing the vehicle to lose traction preventing the vehicle to move in the direction intended and possibly move off the ground mat to the ground leaving tracks or causing other damage to the ground the mats are intended to protect. Slipping may worsen when the ground mats get wet. Conventional ground mats are also inflexible and hard due to the fact they are made out of a high-density polymer. Due to this material choice, these conventional mats do not have sufficient impact resistance and are prone to crack from impact thereby further compromising their impact resistance. The lack of flexibility of the conventional mats makes them hard to place on sloped ground as the conventional mats cannot bend or curve with the grade of the ground.

Accordingly, there is a need to provide and produce a mat with improved grip strength, increased flexibility, softer, improved impact resistance, and higher hydrophobicity. Embodiments of the present disclosure are directed to this and other considerations.

### SUMMARY

Briefly described, embodiments of the presently disclosed subject matter generally relate to mats, mat connectors, and methods of making the mats.

Disclosed embodiments may include a coextruded mat for ground protection. The coextruded mat may include a first material, a second material that is harder than the first material, and an additive blended with the second material to create a third material. The first material may bonded to the third material.

Disclosed embodiments may include a mat for ground protection. The mat may include a first material comprising a plastomer and a second material comprising polyethene that is harder than the first material. The first material may be bonded to the second material via coextrusion.

Disclosed embodiments may include s method of making a mat for ground protection. The method may include mixing a first material with an additive to create a first mixture, providing a first mixture to a coextruder in an amount of about 10-50% by weight of a total amount of material provided to the coextruder, providing a second material, that is harder than the first material, to the coextruder in an amount of about 50-90% by weight of the total amount of material provided to the coextruder, and coextruding the first mixture and the second material to bond the first mixture and the second material to create a combined structure.

### BRIEF DESCRIPTION OF THE DRAWINGS

The accompanying drawings, which are incorporated in and constitute a part of this specification, illustrate multiple embodiments of the presently disclosed subject matter and serve to explain the principles of the presently disclosed subject matter. The drawings are not intended to limit the scope of the presently disclosed subject matter in any manner.

FIG. 1A is a perspective view of an exemplary mat for ground protection, according to an embodiment of the present disclosure.

FIG. 1B is a side view of the exemplary mat of FIG. 1A.

FIGS. 2A-2F are perspective views of exemplary mat connectors according to embodiments of the present disclosure.

FIG. 3 is a perspective view of two exemplary mats connected with two exemplary mat connectors, according to an embodiment of the present disclosure.

FIG. 4 is a perspective view of four exemplary mats connected one exemplary mat connector, according to an embodiment of the present disclosure.

FIG. 5 is an exemplary method for making mats according to embodiments of the present disclosure.

### DETAILED DESCRIPTION

Although certain embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. Other embodiments of the disclosure are capable of being practiced or carried out in various ways. Also, in describing the embodiments, specific terminology will be resorted to for the sake of clarity. It is intended that each term contemplates its broadest meaning as understood by those skilled in the art and includes all technical equivalents which operate in a similar manner to accomplish a similar purpose.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical range and sub-range is explicitly recited. For example, a range of approximately 1 to 99.99 should be interpreted to include not only the explicitly recited limits of approximately 1 and approximately 99.99, but also individual amounts such as 2, 3, 4, 5.01, 5.02, 99.98, etc., and sub ranges such as 5 to 80 and 30.21 to 83.24, etc. Similarly, it should be understood that when numerical ranges are provided, such ranges are to be construed as providing literal support for claim limitations that only recite the lower value of the range as well as claim limitations that only recite the upper value of the range. For example, a disclosed numerical range of 5 to 15 provides literal support for a claim reciting “greater than 5” (with no upper bounds) and a claim reciting “less than 15” (with no lower bounds).

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

The below described embodiments provide superior ground protection compared to other available ground protection. The mats described are less slippery, have higher coefficient of friction (e.g., grip strength), improved impact resistance, higher hydrophobicity, increased flexibility, softer, compared to other available ground mats. Additionally, the various connectors described below provide a solution to protecting the ground, surface, or flooring from vehicles or people by connecting two mats together to help ensure that gaps do not form between two mats where the ground, surface, or flooring could get damaged.

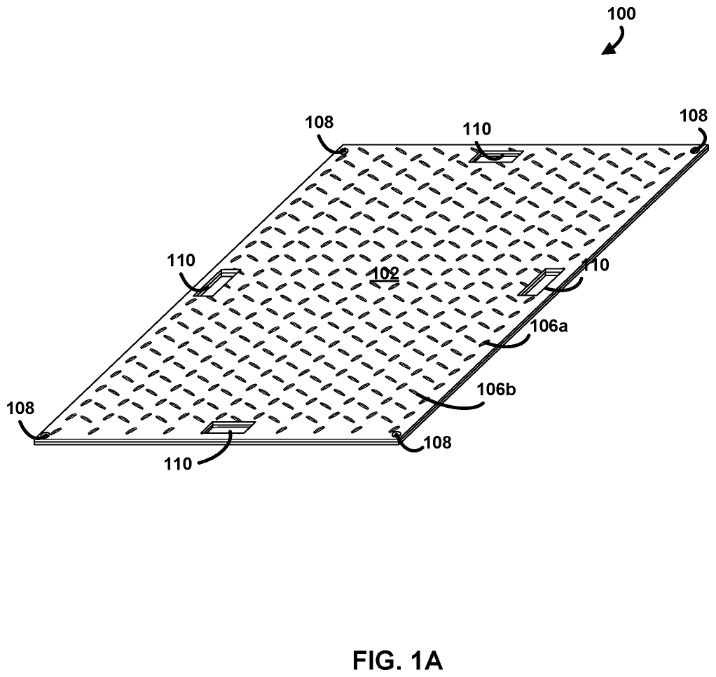

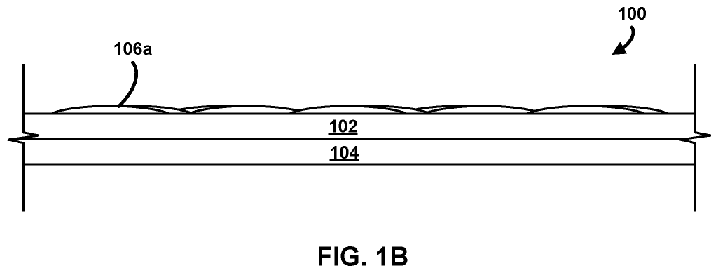

FIG. 1A is a perspective view of an exemplary mat 100 for ground protection, according to an embodiment of the present disclosure. FIG. 1B is a side view of the exemplary mat 100 of FIG. 1A. The mat 100 may include a first material, a second material that is harder (e.g., has a higher Shore D hardness) than the first material, an additive that may be blended with the first material to create a third material. The third material may form a first layer 102 and the second material may form a second layer 104 that is bonded together via coextrusion. When placed on the ground, the first layer 102 containing the softer first material may be the upper layer. The mat may also include one or more raised surfaces 106a that form a pattern to help improve grip for vehicles or people traveling over the mat 100. The mat may include a first surface (optionally having one or more raised surfaces 106a) entirely of the third material and a second surface, opposite of the first surface, comprising entirely of the second material.

In some embodiments, the first material may include a plastomer and the second material may include polyethene. The plastomer may include polyethylene based plastomer, polypropylene based plastomer, ionomer, rubber, thermoplastic elastomers, thermoplastic vulcanizate, or combinations thereof. For example, the first material may include one or more ethylene olefin copolymer. The polyethene may be high density polyethlene, linear low density polyethene, or combinations thereof. The additive may include maleic anhydride.

In some embodiments, the first material may have a first hardness of about 17-19 Shore D and the second material may have a second hardness of about 55 to 70 Shore D. In some embodiments, the mat may have an overall or average hardness of 20-40 Shore D.

In some embodiments, the mat 100 may include about 9-48% by weight of the first material, about 50-90% by weight of the second material, and about 0.1-8% by weight of the additive (e.g., 3-5% by weight of the additive). In some embodiments, the mat may include 75-90% by weight of the second material.

In some embodiments, the mat 100 may include one or more first openings 108. For example, mat 100 shown in FIG. 1A illustrates four first openings 108 that are circular. Each first opening 108 may be configured to receive a portion of one of the connectors 200a-200f described below so that two or more mats 100 may be connected together to minimize and prevent separation when a vehicle (e.g. dump truck) or person is traveling over the mats. In some embodiments, the mat 100 may also include one or more second openings 110. The one or more second openings 110 may be approximately rectangular as shown in FIG. 1A and may be positioned centrally to the closest respective side of the mat 100.

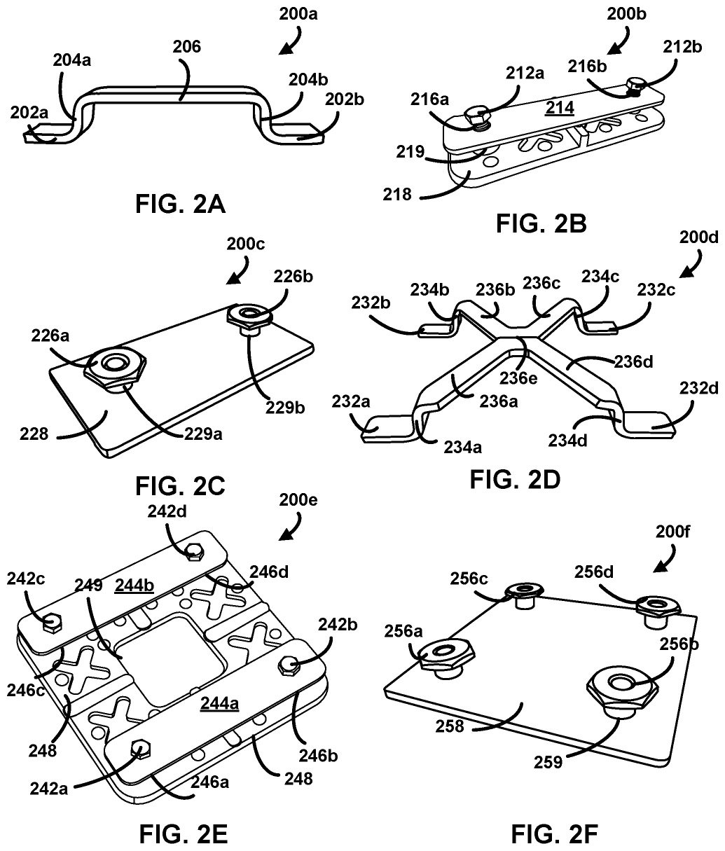

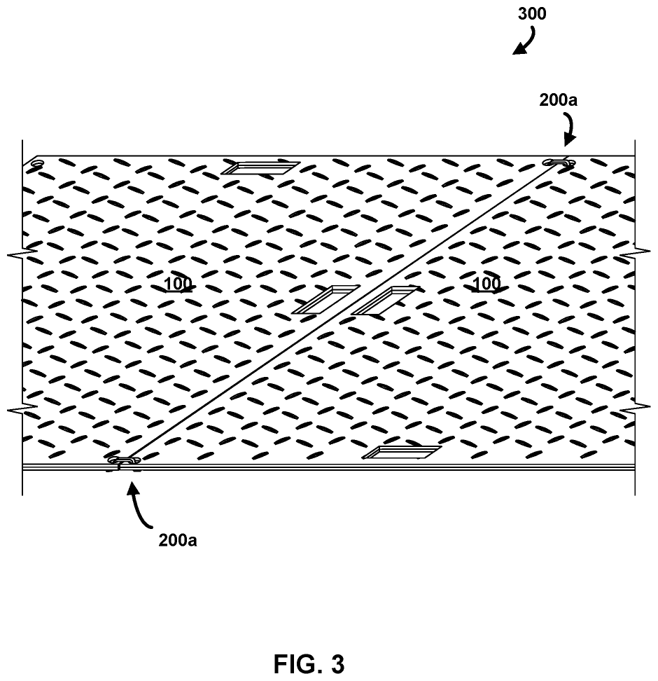

FIGS. 2A-2F are perspective views of exemplary mat connectors 200a-200f according to embodiments of the present disclosure. Two mats 100 may be connected using connector 200a as shown in FIG. 2A. Connector 200a may be a single piece of material (e.g., metal) that is bent into shape. For example, connector 200a may include a first extension portion 202a, a second extension portion 202b, a first vertical portion 204a, a second vertical portion 204b, and longitudinal portion 206. The first extension portion 202a may be directly connected with the first vertical portion 204a via a first bend (e.g., approximately 90-degree bend). The first vertical portion 204a may be directly connected with the longitudinal portion 206 via a second bend (e.g., approximately 90-degree bend). The longitudinal portion 206 may be directly connected to the second vertical portion 204a via a third bend (e.g., approximately 90-degree bend) and the second vertical portion may be directly connected to the second extension portion 202b via a fourth bend (e.g., approximately 90-degree bend). In some embodiments, the first extension portion 202a and the second extension portion 202b may be parallel or approximately parallel. Similarly, the vertical portions 204a, 204b may be parallel or approximately parallel. In some embodiments, the longitudinal portion may be parallel or approximately parallel with the first and second extension portions 202a, 202b. The first extension portion 202a is configured to be inserted into one first opening 108 of the one or more first openings 108 of a mat 100 to latch with the mat 100. The second extension portion 202b is configured to be inserted into one first opening 108 of a different mat 100 to connect both mats 100 as shown in FIG. 3.

Two mats may also be connected using connector 200b as shown in FIG. 2B. Connector 200b may include a base 218 that includes two mechanical female threaded inserts, a plate 214 that includes two plate openings 216a, 216b, a first bolt 212a, and a second bolt 212b. Connector 200b may connect two mats 100 by placing the connector 200b under two mats 100 and aligning the two mechanical female threaded inserts 219 of the base 218, which may be made of high-density polyethylene, with the one first opening 108 of a first mat 100 and another first opening 108 of a second mat 100. Next the plate 214, which may be made of metal, may be placed on top of the two mats 100 and the plate openings 216a, 216b may be aligned with the two mechanical female threaded inserts 219 of the base 218. Finally, the two bolts 212a, 212b may be placed through the respective plate openings 216a, 216b, through the respective first openings of the mats 100, and into the two mechanical female threaded inserts 219 of the base 218 to connect the two mats.

Two mats may also be connected using connector 200c as shown in FIG. 2C. Connector 200c may include a base plate 228 with threaded inserts 229a, 229b configured to receive two bolts 226a, 226b. Connector 200c may connect with two mats 100 similar to connector 200c except without using middle plate 214.

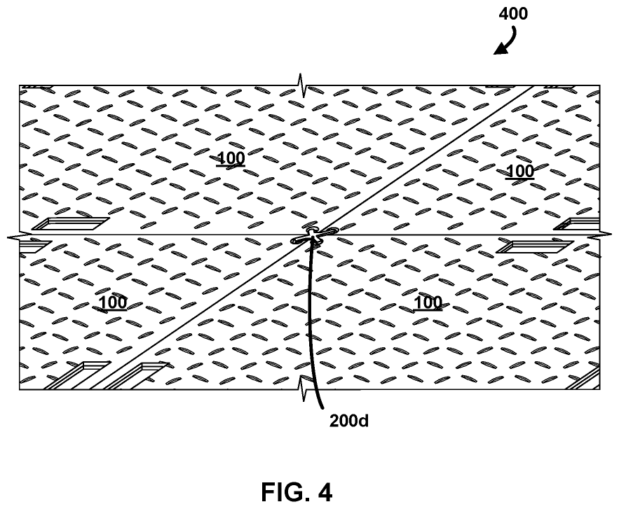

Four mats 100 may be connected using connector 200d as shown in FIG. 2D. Connector 200d may generally have an X shape. Connector 200d may have a first extension portion 232a, a second extension portion 232b, a third extension portion 232c, and a fourth extension portion 232d, a first vertical portion 234a, a second vertical portion 234b, a third vertical portion 234c, a fourth vertical portion 234d, a first longitudinal portion 236a, a second longitudinal portion 236b, a third longitudinal portion 236d, and a center portion 236e. Much like connector 200a, the first, second, third, and fourth extension portions 232a, 232b, 232c, 232d may each be directly respectively connected with the first, second, third, and fourth vertical portions 234a, 234b, 234c, 234d via a first, second, third, and fourth respective bends (e.g., approximately 90-degree each). The first, second, third, and fourth vertical portions 234a, 234b, 234c, 234d may each be directly respectively connected with the first, second, third, and fourth longitudinal portions 236a, 236b, 236c, 236d via a fifth, sixth, seventh, and eighth respective bends (e.g., approximately 90 degrees each). In some embodiments, the first, second, third, and fourth extension portions 232a, 232b, 232c, 232d are parallel or approximately parallel. Extension portions 232a, 232b may extend in the same direction which is opposite that of extension portions 232c, 232d. Similarly, the vertical portions 234a, 234b, 234c, 234d may be parallel or approximately parallel. In some embodiments, the longitudinal portions 236a, 236b, 236c, 236d may form an X shape with center portion 236e and may be parallel or approximately parallel with the first and second extension portions 202a, 202b. The first extension portion 202a is configured to be inserted into one first opening 108 of the one or more first openings 108 of a mat 100 to latch with the mat 100. The second extension portion 202b is configured to be inserted into one first opening 108 of a different mat 100 to connect both mats 100. Extension portions 232a, 232b, 232c, 232d may be inserted into four different first openings 108 in four different mats 100 to connect the corners of four different mats 100 as shown in FIG. 4.

Four mats 100 may also be connected using connector 200e as shown in FIG. 2E. Connector 200e is similar to connector 200b except that it includes a larger base 248 with four threaded inserts 248, four bolts 242a, 242b, 242c, 242d, and two plates 244a, 244b. The base 248 may include an opening 249 to lower the amount of material needed (and associated material cost) of the connector 200e. Connector 200e connects to four mats 100 similar to the way connector 200b does except that connector 200e connects to four first openings 108 of four different mats 100.

Four mats may also be connected using connector 200f as shown in FIG. 2F. Connector 200f may include a base plate 258 with threaded inserts 259 configured to each configured to receive one of four bolts 256a, 256b, 256c, 256d. Connector 200f may connect with two mats 100 similar to connector 200e except without using middle plates 244a, 244b.

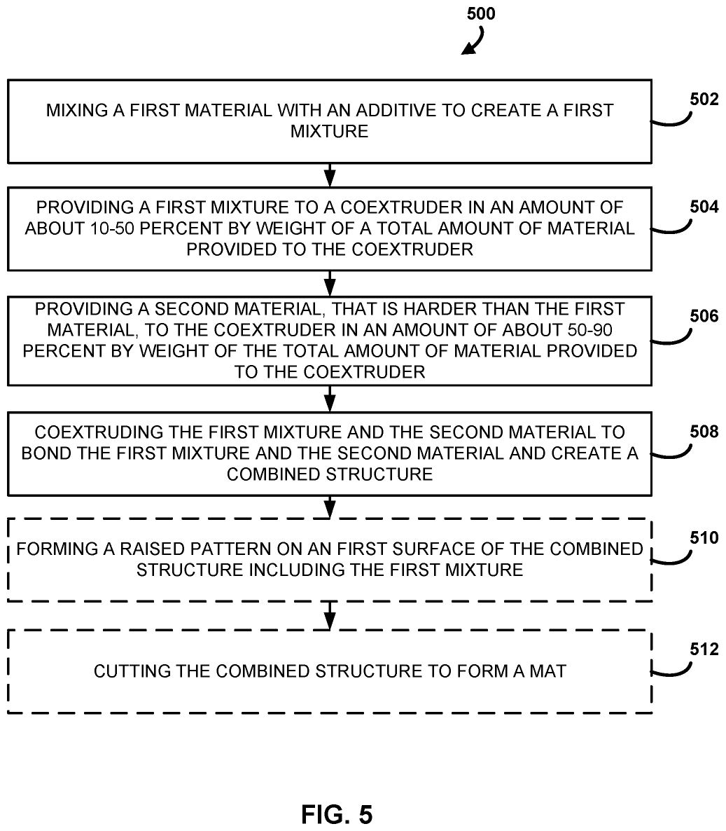

FIG. 5 is an exemplary method 500 for making mats according to embodiments of the present disclosure.

In step 502, method 500 may include mixing a first material with an additive to create a first mixture. As mentioned above, the first material may have a first hardness of about 17-19 Shore D. The first material may include one or more plastomers including polyethylene based plastomer, polypropylene based plastomer, ionomer, rubber, thermoplastic elastomers, thermoplastic vulcanizate, or combinations thereof. The additive may include maleic anhydride.

In step 504, method 500 may include providing a first mixture to a coextruder in an amount of about 10-50% by weight of a total amount of material provided to the coextruder.

In step 506, method 500 may include providing a second material, that is harder than the first material, to the coextruder in an amount of about 50-90% by weight of the total amount of material provided to the coextruder. The second material may include polyethylene.

In step 508, method 500 may include coextruding the first mixture and the second material to bond the first mixture and the second material to create a combined structure.

In optional step 510, method 500 may include forming a raised pattern on a first surface of the combined structure that includes the first mixture. Put another way, the raised pattern may be formed with the materials of the first mixture and not the second material. In other embodiments, the raised structure may be formed with the second material.

In optional step 512, method 500 may include cutting the combined structure to form a mat.

What is claimed is:

1. A coextruded mat, comprising:
a first material;
a second material that is harder than the first material; and
an additive blended with the first material to create a third material, and
wherein the second material is bonded to the third material.

2. The coextruded mat of claim 1, wherein:
the first material comprises plastomer, and
the second material comprises polyethene.

3. The coextruded mat of claim 2, wherein the plastomer comprising polyethylene based plastomer, polypropylene based plastomer, ionomer, rubber, thermoplastic elastomers, thermoplastic vulcanizate, or combinations thereof.

4. The coextruded mat of claim 2, wherein the plastomer comprises ethylene olefin copolymers.

5. The coextruded mat of claim 3, wherein the additive comprises maleic anhydride.

6. The coextruded mat of claim 3, wherein the polyethene is high density polyethlene, linear low density polyethene, or combinations thereof.

7. The coextruded mat of claim 1, wherein the first material has a first hardness of about 17-19 Shore D and the second material has a second hardness of about 55 to 70 Shore D.

8. The coextruded mat of claim 7, comprising an overall hardness of 20-40 Shore D.

9. The coextruded mat of claim 5, comprising:
about 9-48% by weight of the first material;
about 50-90% by weight of the second material; and
about 0.1-2% by weight of the additive.

10. The coextruded mat of claim 9, comprising 75-90% by weight of the second material.

11. The coextruded mat of claim 1, further comprising a first surface comprising entirely of the third material and a second surface, opposite of the first surface, comprising entirely of the second material.

12. The coextruded mat of claim 1, further comprises one or more connectors configured to attach with one or more other mats.

13. A mat, comprising:
a first material comprising a plastomer; and
a second material comprising polyethene that is harder than the first material, and
wherein the first material is bonded to the second material via coextrusion.

14. The mat of claim 13, wherein:
the plastomer comprises polyethylene based plastomer, polypropylene based plastomer, ionomer, rubber, thermoplastic elastomers, thermoplastic vulcanizate, or combinations thereof, and
the polyethene is high density polyethlene, linear low density polyethene, or combinations thereof.

15. The mat of claim 13, wherein the first material has a first hardness of about 17-19 Shore D and the second material has a second hardness of about 55 to 70 Shore D.

16. The mat of claim 13, comprising:
about 10-50% by weight of the first material, and
about 50-90% by weight of the second material.

17. A method of making a mat, comprising:
mixing a first material with an additive to create a first mixture;
providing a first mixture to a coextruder in an amount of about 10-50% by weight of a total amount of material provided to the coextruder;
providing a second material, that is harder than the first material, to the coextruder in an amount of about 50-90% by weight of the total amount of material provided to the coextruder; and
coextruding the first mixture and the second material to bond the first mixture and the second material to create a combined structure.

18. The method of claim 17, wherein the first material has a first hardness of about 17-19 Shore D and the second material has a second hardness of about 55 to 70 Shore D.

19. The method of claim 18, wherein:
the first material comprises one or more plastomers comprising polyethylene based plastomer, polypropylene based plastomer, ionomer, rubber, thermoplastic elastomers, thermoplastic vulcanizate, or combinations thereof,
the second material comprises polyethylene, and
the additive comprises maleic anhydride.

20. The method of claim 18, further comprising:
forming a raised pattern on a first surface of the combined structure comprising the first mixture; and
cutting the combined structure to for a mat.
